(19) United States
(12) Patent Application Publication
(10) Pub. No.: US 2011/0239128 A1
(43) Pub. Date: Sep. 29, 2011

(54) DATA TRANSMISSION METHOD AND DATA TRANSMISSION SYSTEM

(75) Inventors: YU-LIN WANG, NEW TAIPEI CITY (TW); WEI-HUNG CHEN, Shanghai (CN)

(73) Assignees: INVENTEC APPLIANCES (SHANGHAI) CO. LTD., SHANGHAI (CN); INVENTEC APPLIANCES CORP., NEW TAIPEI CITY (TW)

(21) Appl. No.: 13/069,659

(22) Filed: Mar. 23, 2011

(30) Foreign Application Priority Data
Mar. 25, 2010 (CN) 201010131796.6

(51) Int. Cl. G06F 3/00

(52) U.S. Cl. 715/748

(57) ABSTRACT

The present invention relates to a data transmission method and system. The system includes a connection module for setting up a transmission path between a computer end and a device end, a display unit, a capture unit disposed at the device end for capturing an image of the screen including an icon, and a computing unit for recognizing the image to determine that the icon corresponding to an object is shown on the image. The method includes the steps of: displaying a screen including an icon at the computer end; capturing an image including an icon of the screen; recognizing the image to determine that the icon corresponding to an object is shown on the image; and transmitting the object from the computer end to the device end through the transmission path. The present invention does not require complicated operation at the computer end and improves convenience for the application.

### BACKGROUND OF THE INVENTION

1. Field of the Invention

The present invention relates to a communication method and system; and more particularly, to a data transmission method and a data transmission system.

2. Brief Description of the Related Art

As the technology of consumer electronic products advances, various different electronic devices are introduced to the market constantly. The functions of the electronic devices become increasingly diversified, including the integration of communication, photography, music and game functions. Therefore, the multifunctional electronic devices gradually replace the single-functional devices and become very popular.

Since the functions of the electronic devices are improved greatly, the opportunity of transmitting data with a computer becomes increasingly higher. For example, the computing capability of a mobile phone becomes higher and the operating interface becomes more user-friendly, and the mobile phone has the capability of processing files that have to be processed by computers originally. Users can transmit files stored in the computer to the mobile phone to facilitate editing files in the mobile phone.

In general, if a user wants to transmit a file to the mobile phone, the user needs to operate from a computer. For example, a synchronous condition is established between the computer and the mobile phone first, and then an input device such as a keyboard or a mouse is used for clicking and selecting the desired file. In some of the mobile phone products, users may even have to open a specific transmission program at the computer end first before the users can transmit files. Such operation through a computer not only consumes much time, but also causes inconvenience to users for the application.

### SUMMARY OF THE INVENTION

In order to overcome the problem that complicated data transmission steps results in inconvenience for the operation, a primary object of the present invention is to provide a data transmission method and a data transmission system.

With the above object in mind, the present invention provides a data transmission method applied to a computer end and a device end, wherein a transmission path is set up between the computer end and the device end. The method comprises steps of: displaying a screen at the computer end, and the screen including an icon; capturing an image of the screen by the device end, and the image including the icon; recognizing the image to determine that the icon corresponding to an object is shown on the image; and transmitting the object from the computer end to the device end through the transmission path.

According to an embodiment of the present invention, the transmission path is set up based on a wireless communication protocol or a cable communication protocol.

According to an embodiment of the present invention, the wireless communication protocol includes a Bluetooth communication protocol, an infrared transmission communication protocol, or a wireless area network communication protocol. The cable communication protocol includes a universal serial bus communication protocol or an IEEE 1394 communication protocol.

According to an embodiment of the present invention, the icon is a file icon or a folder icon, and the object is a file or a folder.

According to an embodiment of the present invention, the icon is a webpage built-in picture or a figure, and the object is a picture file or a figure file.

According to an embodiment of the present invention, the step of recognizing the image comprises the steps of matching up the image on the screen to obtain a position where the icon is located on the screen, and obtaining the corresponding object according to the position of the icon.

According to an embodiment of the present invention, the image is recognized by the computer end, and before the step of recognizing the image, the method further comprises transmitting the captured image from the device end to the computer end through the transmission path.

The present invention further provides a data transmission system comprising a computer end, a device end, a connection module, a display unit, a capture unit, and a computing unit. The connection module is used for setting up a transmission path between the computer end and the device end. The display unit is disposed at the computer end for displaying a screen, and the screen includes an icon. The capture unit is disposed at the device end for capturing an image of the screen, and the image includes the icon. The connection module is further used for transmitting the image from the device end to the computer end through the transmission path. The computing unit is disposed at the computer end for recognizing the image to determine that the icon corresponding to an object is shown on the image, and the connection module is further used for transmitting the object from the computer end to the device end through the transmission path.

According to an embodiment of the present invention, the device end includes a hand-held electronic device and the capture unit includes an electric coupler or a complementary metal oxide semiconductor.

According to an embodiment of the present invention, the connection module adopts a wireless communication protocol or a cable communication protocol to set up the two-way transmission path.

The present invention has at least the following advantage over the prior arts: it does not require complicated operation at the computer end and thereby improves convenience for the application.

### BRIEF DESCRIPTION OF THE INVENTION

The detail structure, the applied principle, the function and the effectiveness of the present invention can be more fully understood with reference to the following description and accompanying drawings, in which:

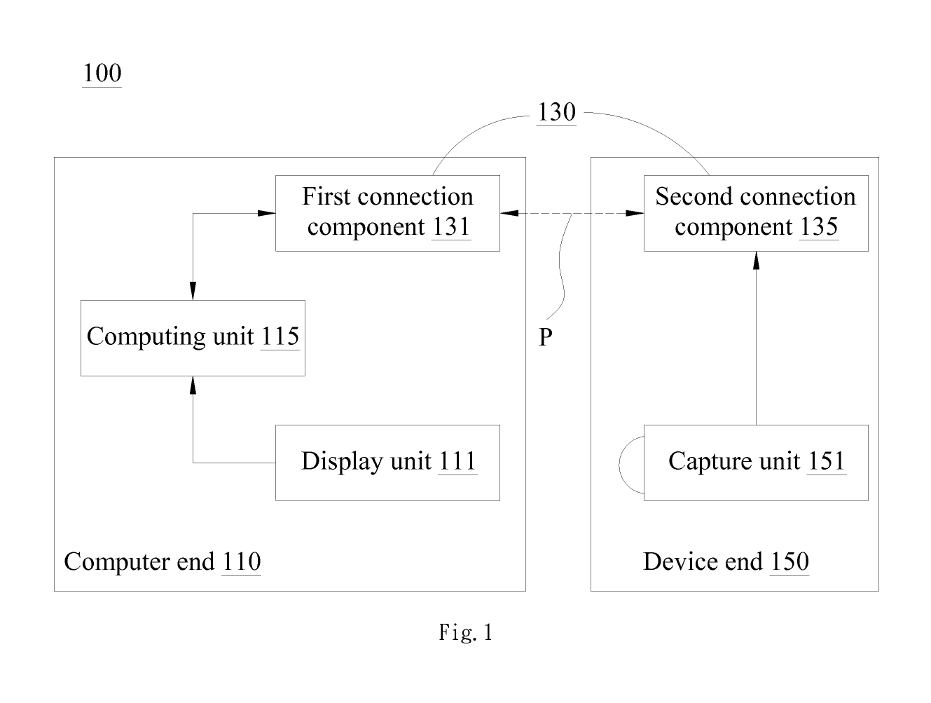

FIG. 1 is a function block diagram of a data transmission system according to an embodiment of the present invention;

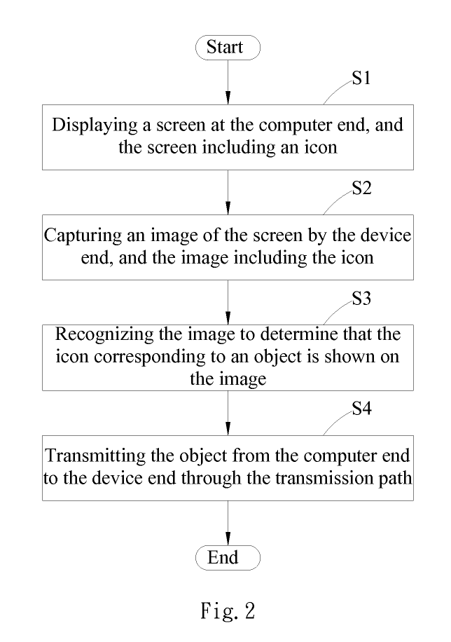

FIG. 2 is a flow chart of a data transmission method according to an embodiment of the present invention;

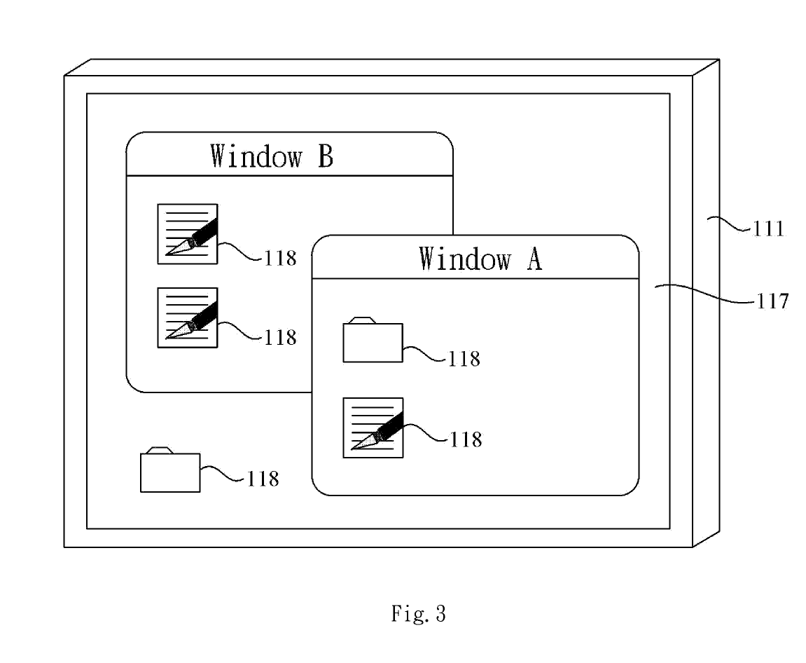

FIG. 3 is a schematic drawing of a screen displayed by a display unit according to the present invention;

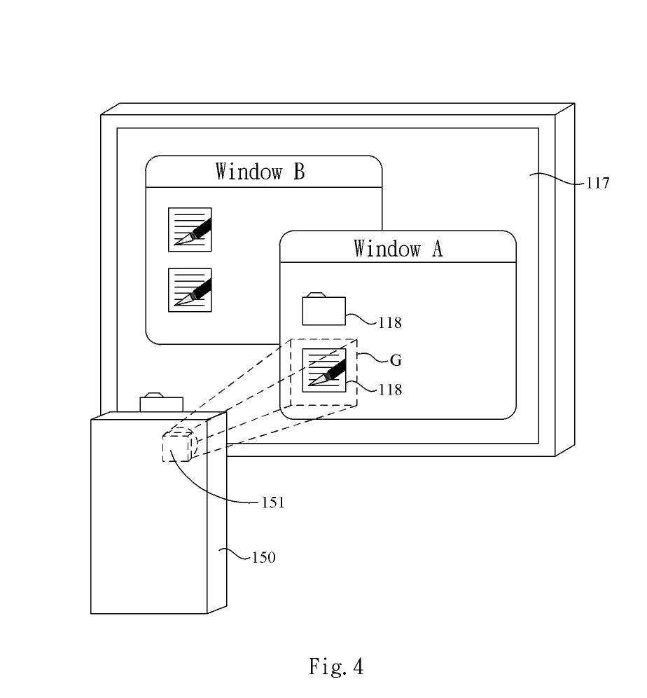

FIG. 4 is a schematic drawing of a capture unit capturing an image of the screen according to the present invention; and

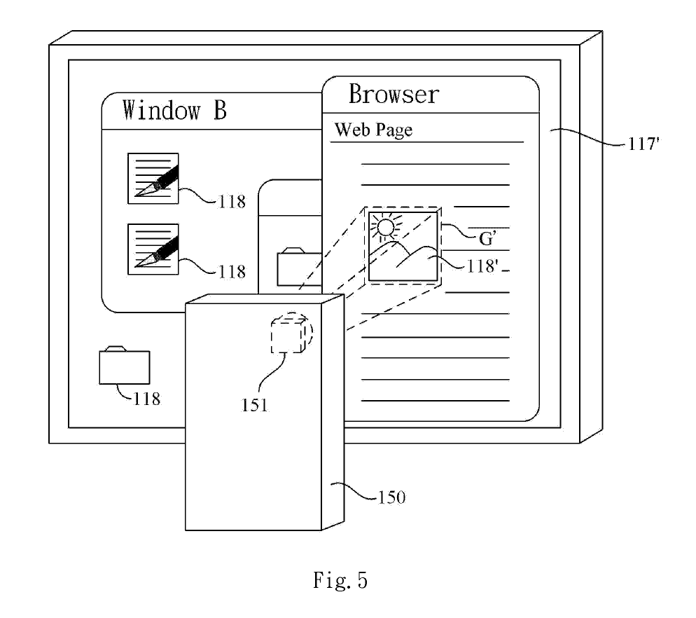

FIG. 5 is a schematic drawing including a webpage built-in picture according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

The data transmission method and data transmission system according to the embodiment of the present invention is capable of obtaining an object to be transmitted by capturing an image of a screen. This allows a straightforward and easy file transmission.

With reference to FIG. 1 illustrating a function block diagram of a data transmission system according to an embodiment of the present invention, the data transmission system 100 at least comprises a computer end 110, a device end 150, and a connection module 130 used for setting up a transmission path P between the computer end 110 and the device end 150. The connection module 130 of the embodiment includes a first connection component 131 and a second connection component 135 disposed at the computer end 110 and the device end 150, respectively. In this embodiment, the transmission path P is set up between the first connection component 131 and the second connection component 135 based on a wireless communication protocol, wherein the transmission path P is capable of performing bidirectional data transmission, and thereby allowing synchronization between the computer end 110 and the device end 150. In practice, the wireless communication protocol may be a Bluetooth communication protocol, an infrared transmission communication protocol, or a wireless area network communication protocol such as IEEE 802.11a/b/g/n.

However, the connection module 130 in accordance with the embodiment of the present invention is not limited to setting up the transmission path P based on a wireless communication protocol; it is also capable of setting up the transmission path P based on a cable communication protocol. For example, a universal serial bus (USB) communication protocol, an IEEE 1394 communication protocol, or other Plug and Play (PnP) connection interface can be used between the first connection component 131 and the second connection component 135. This allows the data to be transmitted from the computer end 110 to the device end 150, and the other way round.

The data transmission system 100 according to the embodiment of the present invention further comprises a display unit 111, a computing unit 115, and a capture unit 151. The display unit 111 and the computing unit 115 are disposed at the computer end 110, and the capture unit 151 is disposed at the device end 150. The display unit 111 is used for displaying a screen including an icon. The capture unit 151 is used for capturing an image of the screen, and the image including the icon. The second connection component 135 transmits the image captured by the capture unit 151 to the computer end 110 through the transmission path P. The computer end 110 receives the image transmitted by the second connection component 135 through the first connection component 131 and transmitting the image to the computing unit 115 for recognizing the image to determine that the icon corresponding to an object is shown on the image. The first connection component 131 is further used for transmitting the object from the computer end 110 to the device end 150 through the transmission path P. The object may be a file or a folder.

According to the data transmission system 100 of the embodiment of the present invention, the computer end 110 may be a laptop or a desktop computer, and the display unit 111 thereof may be a liquid crystal display (LCD), an organic light-emitting display (OLED), or other types of display devices. Further, the device end 150 may be a mobile phone, a PDA, or other types of hand-held electronic devices; and the capture unit 151 may be an electric coupler, a complementary metal oxide semiconductor or other type components capable of capturing an image.

Please refer to FIG. 2 illustrating a flow chart of a data transmission method according to an embodiment of the present invention. In order to allow a simple and clear description of the present invention, the data transmission method of the embodiment is applied to the foregoing data transmission system 100 illustrated is FIG. 1.

Before the data transmission method according to the present embodiment is performed, a transmission path P is set up between the computer end 110 and the device end 150. That is, a transmission path P of the data transmission system 100 is set up based on a wireless communication protocol or a cable communication protocol, wherein the transmission path P is capable of performing bidirectional data transmission, and thereby allowing synchronization between the computer end 110 and the device end 150.

The step S1 describes the step of displaying a screen at the computer end 110. Also, with reference to FIG. 3 that illustrates a schematic drawing of the screen displayed by the display unit according to the present invention, the data transmission system 100 displays a screen 117 with the display unit 111. The screen 117 includes a plurality of icons 118, wherein the icons 118 includes a file icon or a folder icon. In practice, however, the screen 117 is not limited to including only the plurality of icons 118; it is capable of further comprising one or more operating system components, such as windows and desktop pictures, as shown in FIG. 3. In practice, the object that is to be transmitted (such as a file or a folder) is displayed on the screen 117 to allow the performance of the following steps.

The step S2 describes the step of capturing an image of the screen. Also, with reference to FIG. 4 that illustrates a schematic drawing of the capture unit capturing an image of the screen according to the present invention, the data transmission system 100 obtains an image G from the screen 117 by the capture unit 151 of the device end 150. The image G includes at least one icon 118. For example, when the device end 150 is a mobile phone and the capture unit 151 is a camera module thereof, the user is capable of holding the mobile phone with hands and capturing the image G by focusing the camera module on the icon of the file that is to be transmitted. After capturing the image G, the device end 150 transmits the image G to the computer end 110 through transmission path P.

The step S3 describes the step of recognizing the image G. After receiving the image G by the computer end 110, the image G is matched up on the screen 117 by the computing unit 115 so as to find the corresponding icon 118 on the screen 117 and to obtain a position where the icon 118 is located on the screen 117. As the screen 117 shown in FIG. 4, the computer end 110 can obtain a position of the icon 118 and determine whether the icon 118 is located on the desktop, at the window A, or at the window B (in this example, the icon 118 is located at the window A), thereby obtaining the object of the computer end 110 corresponding to the icon 118 in the image G.

As described in step S1, the icons 118 on the screen 117 include a file icon or folder icon. In practice, when the icon 118 of the image G in the step S2 is a file icon, the object matched up in the step S3 is a file; and when the icon 118 of the captured image G is a folder icon, the object matched up in the step S3 is a folder.

The step S4 describes the step of transmitting the object from the computer end 110 to the device end 150. After determining which the object (a file or a folder) is to be transmitted, the computer end 110 transmits the object to the device end 150 through the transmission path P. This allows a convenient and fast obtaining of data, such as files or folders, from the computer end 110.

The icon 118 displayed on the screen 117 in the foregoing embodiment is to take a file icon or a folder icon for an example. However, in another embodiment, the icon also includes a webpage built-in picture (such as graph, chart, or drawing object) or a figure (such as photo), as illustrated in FIG. 5 showing a schematic drawing including the webpage built-in picture according to the present invention. Take a webpage built-in picture for an example here, wherein the webpage built-in picture is a drawing object. When the webpage built-in picture is desired to obtain, the capture unit 151 of the device end 150 captures an image G′ including an icon 118′ from the screen 117, wherein the icon 118′ is the webpage built-in picture. The image G′ is transmitted to the computer end 110, then performing the step of recognizing the image to determine the icon corresponding to object (in this case, the picture file of the webpage built-in picture) is shown on the image and then transmitting the object (the picture file) to the device end 150. When obtaining the webpage built-in picture, the object is an image file. The computer end 110 transmits the image file to the device end 150.

Further, the image G includes an icon 118 in the foregoing embodiment; however, the present invention is not limited to only one icon. In another embodiment, the image G captured by the capture unit 151 can include two or more icons 118. After receiving the image G, the computer end 110 repeats the step S3 for a few times to determine multiple objects corresponding to the icons 118. For example, the device end 150 is capable of obtaining an image comprising two icons 118 and 118′, wherein the icon 118 is a file icon and the icon 118′ is a webpage built-in picture icon. The computer end 110 is capable of recognizing the image G and determining a file corresponding to the icon 118 and a picture file corresponding to the icon 118′, and transmitting the two files to the device end 150.

The data transmission method and data transmission system of the present invention obtain the object to be transmitted by capturing and recognizing the image. This allows a straightforward and easy file transmission and does not require complicated operation at the computer end, thereby being capable of improving convenience for the application.

While the invention has been described with reference to a preferred embodiment thereof, it is to be understood that modifications or variations may be easily made without departing from the spirit of this invention, which is defined in the appended claims.

What is claimed is:

1. A data transmission method applied to a computer end and a device end, wherein a transmission path is set up between the computer end and the device end, and the method comprises steps of:
displaying a screen at the computer end, and the screen including an icon;
capturing an image of the screen by the device end, and the image including the icon;
recognizing the image to determine that the icon corresponding to an object is shown on the image; and
transmitting the object from the computer end to the device end through the transmission path.

2. The data transmission method of claim 1, wherein the transmission path is set up based on a wireless communication protocol or a cable communication protocol.

3. The data transmission method of claim 2, wherein the wireless communication protocol includes a Bluetooth communication protocol, an infrared transmission communication protocol, or a wireless area network communication protocol, and the cable communication protocol includes a universal serial bus communication protocol or an IEEE 1394 communication protocol.

4. The data transmission method of claim 1, wherein the icon is a file icon or a folder icon, and the object is a file or a folder.

5. The data transmission method of claim 1, wherein the icon is a webpage built-in picture or a figure, and the object is a picture file or a figure file.

6. The data transmission method of claim 1, wherein the step of recognizing the image further comprising the steps of:
matching up the image on the screen to obtain a position where the icon is located on the screen; and
obtaining the corresponding object according to the position of the icon.

7. The data transmission method of claim 1, wherein the image is recognized by the computer end, and before the step of recognizing the image, the method further comprises:
transmitting the captured image from the device end to the computer end through the transmission path.

8. A data transmission system, comprising:
a computer end and a device end;
a connection module used for setting up a transmission path between the computer end and the device end;
a display unit disposed at the computer end for displaying a screen, and the screen including an icon;
a capture unit disposed at the device end for capturing an image of the screen, and the image including the icon, and the connection module further used for transmitting the image from the device end to the computer end through the transmission path; and
a computing unit disposed at the computer end for recognizing the image to determine that the icon corresponding to an object is shown on the image, and the connection module further used for transmitting the object from the computer end to the device end through the transmission path.

9. The data transmission system of claim 8, wherein the device end includes a hand-held electronic device and the capture unit includes an electric coupler or a complementary metal oxide semiconductor.

10. The data transmission system of claim 8, wherein the connection module adopts a wireless communication protocol or a cable communication protocol to set up the two-way transmission path.
